(19) United States
(12) Patent Application Publication
(10) Pub. No.: US 2015/0249920 A1
(43) Pub. Date: Sep. 3, 2015

(54) PRESSURE-ENABLED NEAR FIELD COMMUNICATIONS DEVICE

(71) Applicant: TOSHIBA GLOBAL COMMERCE SOLUTIONS HOLDINGS CORPORATION, Tokyo (JP)

(72) Inventors: Christ LESTARIO, Singapore (SG); Dhanalakshmi Kalyana SUNDARAM, Singapore (SG); Tian Koon LEE, Singapore (SG)

(73) Assignee: TOSHIBA GLOBAL COMMERCE SOLUTIONS HOLDINGS CORPORATION, Tokyo (JP)

(21) Appl. No.: 14/195,304

(22) Filed: Mar. 3, 2014

(51) Int. Cl. H04W 12/06; H04W 4/00

(52) U.S. Cl. CPC H04W 12/06; H04W 4/008

(57) ABSTRACT

A method and a near field communication (NFC) device are described for authenticating NFC devices to limit or prevent unauthorized use. The method and NFC device selectively enable an NFC tag, so that communication between the NFC device and another NFC device may be enabled only after a user has provided authentication. The authentication device of the NFC device may include a piezoelectric element that provides power and authentication data to a processor that performs the authentication operation, which may include matching an authentication signal to a stored authentication signal.

### BACKGROUND

The disclosure relates to wireless communications, and more specifically, to authentication of wireless devices.

Radio frequency identification (RFID) devices provide a convenient, accurate, and inexpensive mechanism for identifying or tracking objects, and for other wireless data communication. RFID devices, including those using near field communication (NFC), are beneficially implemented in a number of different industries: inventory systems, completing commercial transactions, providing keycard access, storing electronic identity documents, and so forth. However, RFID and NFC devices generally do not include a native authentication capability, so that a lost or stolen device (such as a NFC payment card) may be used by another without detection.

### SUMMARY

According to one embodiment of the present invention, a method for authenticating a NFC device is provided. The NFC device includes an authentication device, and the method includes, in response to receiving at the authentication device a pressure pattern corresponding to an authentication signal that matches a stored authentication signal, enabling a NFC tag of the NFC device to enable communication with another NFC device.

According to one embodiment of the present invention, a NFC device is provided that includes an NFC tag and an authentication device that is configured to selectively enable the NFC tag based on a received pressure pattern, and thereby selectively enable communication between the NFC device and another NFC device.

According to one embodiment of the present invention, a self-powered input device is provided that includes a processor configured to receive power and data from a piezoelectric element.

### BRIEF DESCRIPTION OF THE SEVERAL VIEWS OF THE DRAWINGS

So that the manner in which the above recited aspects can be understood in detail, a more particular description of embodiments of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a configuration of NFC devices, according to embodiments described herein.

FIG. 2 depicts an authentication device included in a NFC device, according to embodiments described herein.

FIG. 3A depicts an interaction between NFC devices, according to embodiments described herein.

FIGS. 3B-3D depict touch patterns provided to an authentication device, according to embodiments described herein.

FIG. 4A is a block diagram depicting a method for storing an authentication signal in a NFC card, according to embodiments described herein.

FIG. 4B is a block diagram depicting a method for authenticating a NFC device, according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation. The illustrations referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

NFC devices may include an authentication device that is configured to selectively enable an NFC tag located in the NFC device, so that communication between the NFC device and another NFC device may be enabled only after a user has provided authentication. By including the authentication functionality for a NFC device, unauthorized uses of the device may thereby be limited or prevented entirely.

Even for passive NFC target devices, which typically do not include an independent power supply (and thus do not typically include any native processing capability to perform authentication), the authentication functionality may be included as part of the target device. The authentication device may include a piezoelectric element configured to provide both power as well as authentication data to a processor that performs the authentication processing. The piezoelectric element may be a planar piezoelectric film having a plurality of sensing points, so that a user-applied pressure pattern on the piezoelectric film may generate charge at one or more of the sensing points, which may then be used to generate an authentication signal. The processor may compare this signal to a stored authentication signal, and if the signals match (or are determined to be sufficiently close to matching), the processor may output an enable signal to the NFC tag, and thus may selectively enable communications with another NFC device.

Of course, the principles and techniques described herein may be applied to other RFID devices with similar benefits.

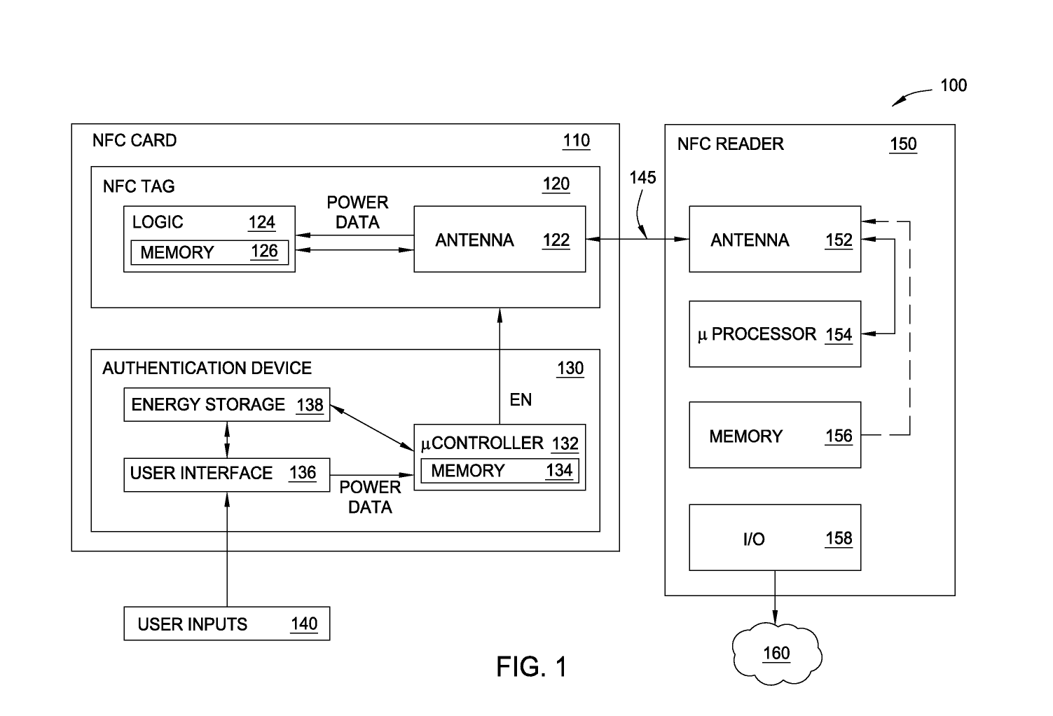

FIG. 1 depicts a configuration of NFC devices, according to embodiments described herein. The configuration of NFC devices 100 includes a NFC card 110 and a NFC reader 150 that are configured to communicate with each other, and with other NFC devices. Communicating NFC devices may generally be classified as either an initiator device or a target device; the initiator device actively generates a radio frequency (RF) field that is inductively coupled by a passive target device, thereby providing power and data to the target device. Other configurations may provide for active NFC devices that each generate a RF field for communicating.

NFC generally includes a set of short-range wireless technologies and prescribed standards, typically requiring a distance of 10 centimeters (cm) or less to support communication between devices, but which may range from 4-20 cm. Beyond a measure of proximity to each other, the NFC devices may also be constrained to certain operating parameters prescribed by one or more industry standards, such as International Organization for Standardization (ISO)/International Electrotechnical Commission (IEC) 18092, ISO/IEC 14443, ISO 18000-3, and so forth. However, the principles and techniques described herein may apply equally to wireless devices operating outside of these standards, whether the devices are generally classified as RFID devices, or whether they are unregulated.

While NFC card 110 and NFC reader 150 have been selected for simplicity of presentation, many other types of NFC devices may operate in a same or similar manner. NFC card 110 may serve as a security key card, a payment card, etc., having any feasible shape and size. The components of NFC devices may be selectively arranged in a form factor of any feasible size or shape; common NFC devices may be comparable in size to credit and identification cards, but NFC devices may alternately be provided with enhanced protective, ergonomic, or aesthetic qualities.

NFC card 110 includes a NFC tag 120, which in turn includes an antenna 122 and logic module 124. NFC card 110 may be a passive target device, configured to receive power and data from NFC reader 150. Logic module 124 may be provided as various active or passive circuitry onboard the NFC card, such as wired logic or a microcontroller. In many cases, logic module 124 may be constrained by a limited amount of power available to the NFC card. The logic module is coupled to a memory 126, which is typically non-volatile so that stored data may be preserved even though power to the NFC card may be sporadic (i.e., the NFC card only receives power when coupled to another NFC device). The NFC card 110 may provide encryption for protecting data at rest in memory 126. Antenna 122 may be included as a discrete component, or may be formed using circuit traces generally designed to receive and transmit RF energy within a certain frequency range. For example, the antenna may be configured to receive and transmit data at approximately 13.56 megahertz (MHz), according to accepted standards. Of course, wireless devices not constrained by NFC standards may be operated at any other feasible frequency.

NFC reader 150 includes an antenna 152, as well as other components ordinarily found in computing devices: a microprocessor 154, memory 156, and input/output (I/O) interfaces 158. The NFC reader 150 may be networked to other computing devices through network 160 using at least one of its I/O interfaces 158. NFC reader 150 may be an initiator device, configured to provide power and data to the NFC card 110. The NFC reader may be any sort of device ranging from a proximity card reader, a terminal connected to a cash register, a standalone terminal, a tablet, a cell phone, and so forth. Microprocessor 154 may comprise any type of processing element, and may include single or multiple processor configurations, multi-core processors, etc. Microprocessor 154 generally reads from and writes to memory 156, transmitting to and receiving data from antenna 152; alternate embodiments may include direct memory accessing (DMA) where data from memory may be transmitted to antenna 152 by a separate memory management unit (not pictured) without requiring processing by microprocessor 154. Antenna 152 may be the same or operate the same or similar to antenna 122; antenna 152 may alternatively include components capable of transmitting stronger signals, especially where NFC reader 150 is an initiator device and required to provide power for a passive target device.

In several embodiments, NFC card 110 also includes an authentication device 130, which includes a microcontroller 132 and a memory 134. Microcontroller 132 may generally operate the same or similarly to microprocessor 154 described above, and memory 154 may generally operate the same or similarly to memory 126 described above.

Authentication device 130 also includes a user interface 136 configured to receive user inputs 140. User interface 136 may include a piezoelectric element, which when receiving user inputs, is configured to transmit both power and data to the microcontroller. In alternate embodiments, user interface 136 may include any other feasible devices or combinations of devices for receiving user inputs 140; for example, may include fingerprint or other biometric readers, capacitive or resistive touch screens, and so forth.

The piezoelectric element may independently provide power for microcontroller 132, thus enabling operation of the microcontroller without requiring an external power source. Authentication device 130 may further include an energy storage element 138 configured to store excess power that is not used by the microcontroller; for example, energy storage element 138 may be a capacitive circuit, rechargeable battery, etc., or combinations thereof. The energy storage element may be used to provide power to the microcontroller (or other circuitry) concurrently with the power delivered by the piezoelectric element, or could be selectively employed when the power from the piezoelectric element is determined to be insufficient to continue operating the microcontroller. In alternate embodiments, authentication device 130 may also be coupled to the antenna 122, and may be configured to receive and use (i.e., store or apply to the microcontroller) power provided to the NFC card through signals 145.

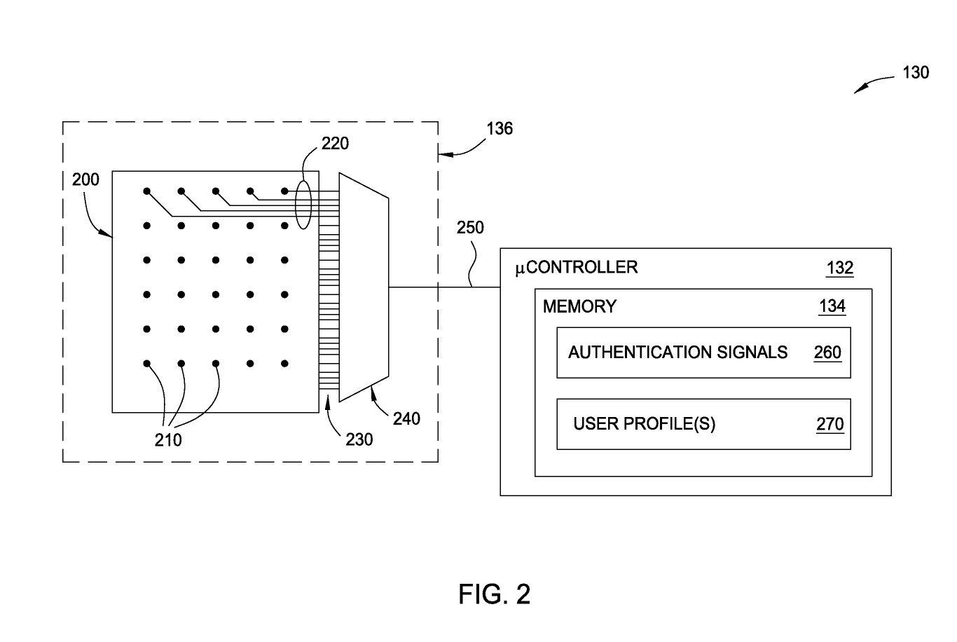

FIG. 2 depicts an authentication device included in a NFC device, according to embodiments described herein. Authentication device 130 includes, as part of user interface 136, a piezoelectric element 200 that is generally consistent with the piezoelectric element described above. Of course, user interface 136 may include alternate or additional devices for receiving user inputs. The piezoelectric element may have a relatively flat, planar surface such as a film and may include a plurality of discrete sensing points 210. Piezoelectric element 200 may be formed by deposited material onto a substrate or other support structure. While shown as rectangular, the piezoelectric element may have any desired shape or size. The piezoelectric element may be disposed within the housing of NFC card 110 and entirely enclosed by the housing, or the piezoelectric element may be at least partially exposed on a surface of the NFC card. Of course, other configurations of the piezoelectric element are also possible (such as a networked array of discrete piezoelectric point sensors or linear filaments, or combinations of different piezoelectric elements), each configuration offering a different signal quality and resolution.

Sensing points 210 may each be configured to detect charge (for example, as a voltage or current) induced by pressure on the piezoelectric element 200 occurring at or near the particular point. Sensing points may be formed in or on the piezoelectric element 200, or alternately may be disposed adjacent to the piezoelectric element, such as on the substrate. Each of the sensing points may be electrically connected to microcontroller 132 using one or more wires or traces 220, 230. The piezoelectric element may also include a multiplexer 240 that is configured to reduce the number of distinct lines (i.e., wires or traces) needed to transmit charge received at the sensing points to the microcontroller. Generally, by reducing the number of wires or traces, less space will be required for housing and connecting to the piezoelectric element, thus permitting smaller or customized NFC devices. Of course, any ratio and multiplexing technique (for example, time or frequency multiplexing) may be used. For example, 25 lines corresponding to the 25 discrete sensing points 210 depicted could be reduced by multiplexer 240 to a single line 250 coupled to microcontroller 132, a 25:1 ratio. And while sensing points 210 are arranged in an array of aligned rows and columns, the sensing points may be arranged in any feasible configuration, such as staggered rows or columns, a radial pattern, etc. Sensing points 210 may alternately have shapes with various dimensions, such as lines or geometric shapes.

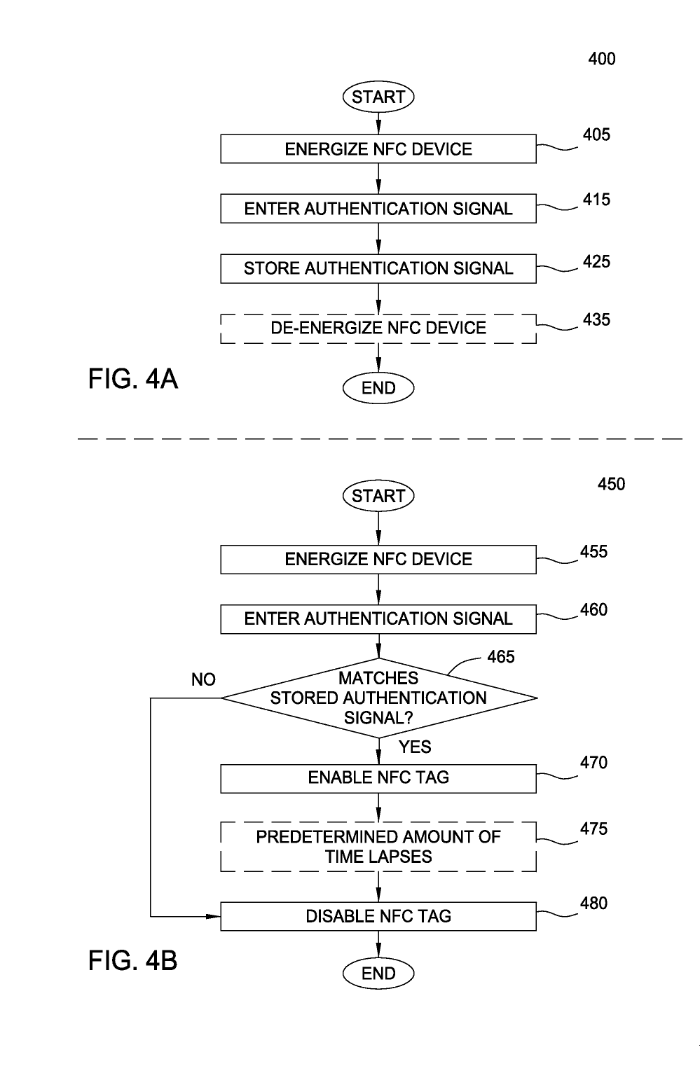

Microcontroller 132 may have one or more inputs and may include internally a demultiplexing functionality, especially where receiving data from a number of sensing points greater than number of inputs. Alternatively, microcontroller 132 does not include a demultiplexing functionality, but receives and processes the signal provided by the piezoelectric element 200. The microcontroller may be configured to convert the received signals (whether multiplexed or not) from line or lines 250 into a more suitable format for detecting similarities or differences in signals, and may further include filtering, compression, or other known signal processing techniques. The processing performed on received signals may be intended to optimize the signals, such as providing acceptable (or best possible) data resolution within size constraints of memory 134. The entry and processing of signals will be discussed further below with respect to FIGS. 4A and 4B.

An authentication device 130 included in an NFC card 110 may also provide a capability for multiple user identification, which may be especially useful when the corresponding NFC device (such as NFC reader 150) is linked to personal accounts or other user settings. For example, a single NFC payment card could be used to complete commercial transactions by different individuals, so that depending on which user interacts with NFC reader 150 by providing authentication on NFC card 100, the appropriate user account would be charged or debited. In another example, a single user may be able to select which account to charge (say, different types of accounts or accounts with different banks) by providing a different authentication signal. Of course, this may also be extended to other applications; a car having a NFC key might change settings (seat position, climate control, radio stations, etc.) based on the authenticated user of the NFC key. In another example, an authenticated user of a NFC security badge could also be logged for security purposes.

To implement multiple user identification, microcontroller 132 may include in its memory one or more user profiles 270. These profiles may each correspond to a respective authentication signal stored in authentication signals 260, and may include information that can be read by NFC reader 150, such as account information needed for completing commercial transactions. Of course, microcontroller 132 may be configured to encrypt data stored in memory 134 to protect potentially sensitive information. After determining the authenticated user, microcontroller 132 may modify the output of NFC tag 120 based on the user profiles. For example, microcontroller 132 could send output signals directly to antenna 122, or could rewrite portions of memory 126, reflecting the authenticated user profile, so that NFC reader 150 ultimately receives a desired signal 145, such as (in the case of a commercial transaction) the account information for the authenticated user, or other information needed to complete the commercial transaction.

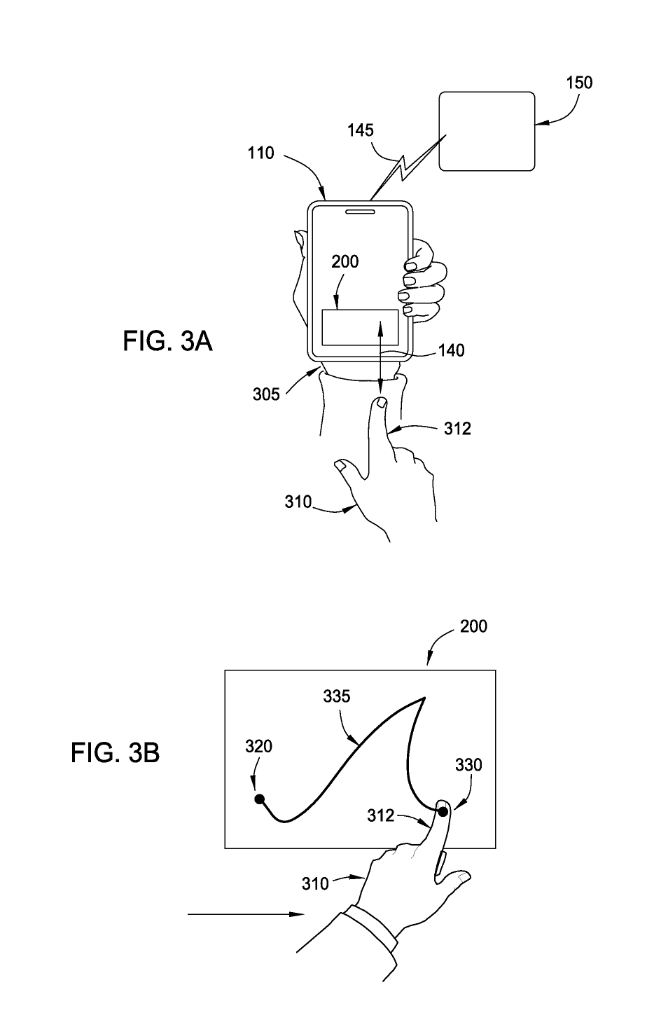

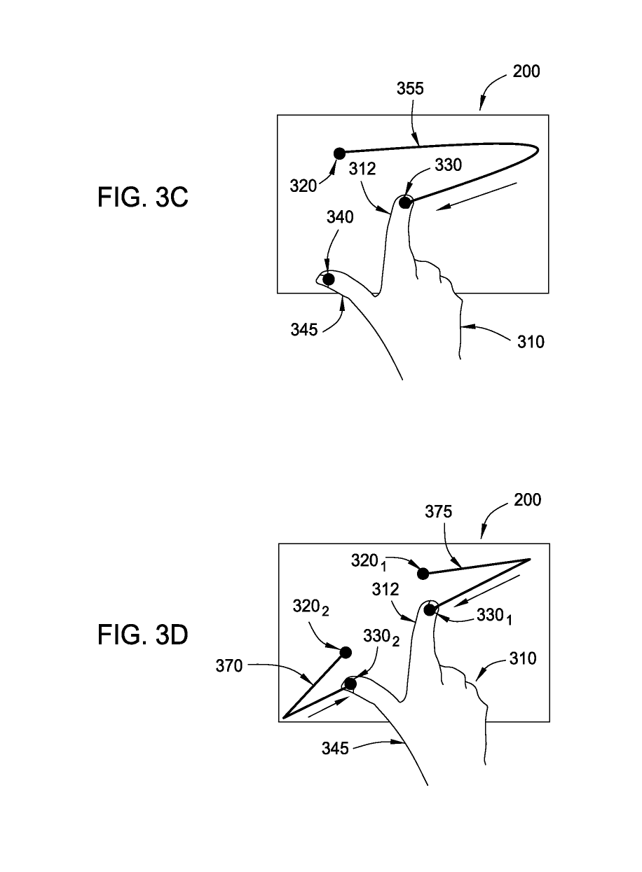

FIG. 3A depicts an interaction between NFC devices, according to embodiments described herein. Shown are NFC card 110 with piezoelectric element 200, and NFC reader 150, each of which are generally as described above. The NFC reader 150 may be any type of NFC device, such as a point-of-sale terminal, a security badge reader, etc. The NFC card as shown is held by a user's left hand 305, while user's right hand 310 (in this case, an index finger 312 specifically) provides a pressure pattern to the piezoelectric element 200 by pressing against the surface of the NFC card 110 (in this case, the user's left hand provides the counteracting force necessary to generate pressure). Alternatively, the pressure pattern could be entered by one hand of the user; for example, the user could hold the NFC card with one hand and manipulate the NFC card surface using the thumb of that hand. Of course, any feasible configuration could work (using three fingers on the surface, different users' fingers, pressing while the card is adjacent to an object, and so forth).

The NFC card may be configured to be energized by receiving power from either (or both of) input at antenna 122 or input at piezoelectric element 200. The antenna 122 may receive a signal 145 from NFC reader 150 when NFC card 110 is within a predetermined distance of the NFC reader; for example, within 20 cm. Alternately, the user may provide pressure on the surface of NFC card 110 which provides power to on-board circuitry such as microcontroller 132.

Though a user may not yet have provided authentication to NFC card 110, an NFC tag may ordinarily be configured to respond to signals sent by NFC reader 150, and may begin transmitting data substantially immediately. In order to effectively provide the authentication function, the NFC tag may be selectively disabled; the NFC tag may be disabled by default, or the authentication device may be configured to affirmatively disable the NFC tag. At a minimum, disabling the NFC tag means that it is unable to transmit data out to another NFC device, but may still able to receive a power or data signal from that device; alternatively, disabling the NFC tag may prevent communication in both directions.

To disable the NFC tag, the microcontroller may provide, e.g., an appropriate signal such as a logical “zero” signal to an enable input of the logic module 124 of the NFC tag; the microcontroller may alternately modify operating parameters of the NFC tag (such as modifying the tag's frequency settings or protocols so that it cannot couple with the NFC reader), or may physically disrupt the normal transmission operation of the NFC tag at various stages of the operation. Examples of physical disruption may include erasing or modifying the contents of memory 126, shorting a circuit path to the memory or to the antenna (e.g., using a controllable ground/high-impedance path coupled to the circuit path), sending various signals to the antenna 122 to garble the data received from the memory 126, and so forth.

Conversely, the microcontroller may enable the NFC card by reversing or undoing any affirmative functions performed to disable the NFC card; for instance, the microcontroller may send a logical “one” to the enable input or may stop any physical disruption measures. After enabling the NFC tag, the NFC card may begin transmitting data to other NFC devices.

FIGS. 3B-3D depict touch patterns provided to an authentication device, according to embodiments described herein. The touch patterns could be provided in a configuration like that of FIG. 3A, in which a user holds NFC card in one hand while manipulating the PE element with the other hand. Of course, these are only non-limiting examples and any feasible pattern could be used, perhaps constrained by an amount of memory available to store the authentication signal generated in response to the touch pattern. FIG. 3B shows a touch pattern 335 having a start point 320 and end point 330, where index finger 312 of user right hand 310 presses against the surface of NFC card 110 while moving along the touch pattern. Of course, any feasible pattern may be selected, such as a different shape, or having varying pressure along the touch pattern (e.g., gradually less pressure as the user progresses along the touch pattern to end point 330).

Touch patterns may also include discontinuous or time-dependent patterns. For example, a user might provide a particular number or sequence of pressure pulses (such as taps, or tap-and-hold) at one or several locations on the authentication device. Touch patterns may also include multiple pattern segments that are separated by periods of non-touching. For example, a user whose input pattern includes pressing in the shape of a letter “T” may lift and reapply a finger to the authentication device. Accordingly, the microcontroller 132 may be configured to detect and distinguish different authentication signals according to pressure amplitude, spatial locations, times of pressure pulses, times between pressure pulses, counts of pressure pulses, and so forth. In one embodiment, microcontroller 132 may ignore times between pressure pulses or pattern segments, and may construct the authentication signal using those time periods where pressure is applied to the authentication device.

In some embodiments, the authentication device may also support multi-touch input, such as is depicted by FIGS. 3C and 3D. In FIG. 3C, a thumb 345 of user right hand 310 is relatively stationary while providing pressure at point 340 while the index finger 312 moves according to touch pattern 355, from start point 320 to end point 330. In FIG. 3D, index finger 312 moves according to touch pattern 375 from start point 320₁ to end point 330₁, concurrent with thumb 345 moving according to touch pattern 370, from start point 320₂ to end point 330₂.

The finger movement along the two touch patterns may generally begin and end at about the same times, and the rate of finger movement along touch patterns 370 and 375 may be substantially similar.

FIG. 4A is a block diagram depicting a method for storing an authentication signal in a NFC card, according to embodiments described herein. For example, method 400 may be performed during an initial use of the NFC card, and a first stored authentication signal may serve as a reference signal in subsequent authentication operations. Method 400 may also be performed any time a new user or new authentication signal is desired (e.g., same user wants to add a second account). The NFC card is used as an example; generally, any NFC device having a NFC tag may use method 400.

Method 400 begins at block 405, where the NFC card is energized. As described above, the NFC card may be configured to be energized by receiving power from either (or both of) input at antenna 122 or input at the user interface (e.g., at piezoelectric element 200). The antenna 122 may receive a signal 145 from NFC reader 250 when NFC card 110 is within a predetermined distance of the NFC reader; for example, within 20 cm. Alternately, the user may provide pressure on the surface of NFC card 110 which provides power to on-board circuitry such as microcontroller 132. After the NFC card is energized, the card may provide an indication to the user that it is ready for the authentication signal to be entered, such as by providing audio, visual, and/or tactile feedback to the user.

At block 415, an authentication signal is entered. Entry may typically be performed by a user providing input to the user interface of the authentication device; one example may be providing a pressure pattern at the piezoelectric element. The entered input generates an authentication signal to the microcontroller.

Alternately, the authentication signal could be provided by another NFC device (such as a computer, cell phone, etc.) transmitting previously recorded signal information for the user to the NFC card via the antenna to the microcontroller, which in the next block may save the information to the authentication signals 260 portion of memory 134.

At block 425, the authentication signal in stored in memory. The authentication signal may generally be written to the authentication signals 260 portion of memory 134, but alternately could be written to the memory within NFC tag 120. As the NFC device now includes at least one authentication signal, subsequent authentication signals may be compared to this stored signal in order to authenticate a user.

At block 435, the NFC card is de-energized. This block may be optional, as the NFC card may remain energized for at least a period of time even in the absence of further power input from the user interface (from a piezoelectric element or otherwise). For example, energy delivered from energy storage device 138 or from antenna 122 may continue to power NFC card 110. Method 400 ends after the NFC card has been de-energized.

FIG. 4B is a block diagram depicting a method for authenticating a NFC device, according to embodiments described herein. Method 450 may generally occur after method 400, as at least one stored authentication signal is typically required to compare against a currently entered signal, in order to authenticate a user. As with method 400, the NFC card is used as an example; generally, any NFC device having a NFC tag may use method 450.

At block 455, the NFC card is energized. This block is generally the same or substantially similar to block 405 of method 400. If method 450 follows substantially immediately after method 400, or if the NFC card remains energized for any other reason, this block may be omitted. After the NFC card is energized, the card may provide an indication to the user that it is ready for the authentication signal to be entered, such as by providing audio, visual, and/or tactile feedback to the user. The user may then provide their desired input, which generates an authentication signal.

At block 460, an authentication signal is entered. This block is similar to block 415 of method 400, but entry will be performed at the user interface of the authentication device, e.g., by providing a pressure pattern at the piezoelectric element. The entered authentication signal may be stored in memory prior to the microcontroller determining whether the entered signal matches a previously stored authentication signal.

At block 465, the microcontroller may determine whether the entered authentication signal matches the stored authentication signal. The microcontroller may generate a matching score representing a measure of similarity of the two signals, which could be calculated according to any number of known signal analysis techniques. Generally, the techniques may be based on certain properties of the signals, such as location (i.e., identifying using the signals which sensors received the charge), amplitude, input speed, frequencies, and so forth. The resulting matching score may be compared against a minimum threshold value, which may be an absolute value or a percentage; if the matching score exceeds the threshold value, the microcontroller may determine the two signals to be a “match,” and the method proceeds to block 470. However, if the signals are determined to not be a match, the method proceeds to block 480.

In embodiments supporting multiple users or multiple authentication signals (e.g., a user with multiple signals linked to different information), the microcontroller may compare the entered authentication signal with some or all of the stored authentication signals in generally the same manner. The microcontroller may generate a matching score for each of the comparisons. The microcontroller may then determine one of the stored authentication signals to be a match with the entered signal, based on a matching score exceeding the threshold value. If multiple stored signals exceed the threshold value, the microcontroller may select the stored signal having the higher or highest score, may perform a secondary comparison using different techniques, or may reject the entered signal and prompt the user to re-enter the authentication signal (i.e., method 450 loops back to block 460). If a match is found, the method proceeds to block 470; else the method proceeds to block 480.

At block 470, and in response to receiving the matching authentication signal, the NFC tag is enabled, thus enabling the NFC card to communicate with another NFC device. During operation of the NFC card, the NFC tag may be disabled by default (meaning that the tag is at least unable to transmit data out, but may still able to receive a power or data signal), whether due to the intrinsic design of the NFC tag or by some operation of the microcontroller. The microcontroller may provide, e.g., a logical “zero” signal to an enable input of the logic module 124 of the NFC tag, or may physically disrupt the normal transmission operation of the NFC tag. Examples of physical disruption may include erasing or rewriting memory 126, shorting a circuit path to the memory or to the antenna (e.g., using a controllable ground/high-impedance path coupled to the circuit path), sending various signals to the antenna 122 to garble the data received from the memory 126, and so forth.

The microcontroller may enable the NFC card by reversing or undoing any affirmative functions performed to disable the NFC card; for instance, the microcontroller may send a logical “one” to the enable input or may stop any physical disruption measures. After enabling the NFC tag, the NFC card may begin transmitting data to other NFC devices and the method proceeds to block 475.

At block 475, a predetermined amount of time may elapse after enabling the NFC tag. To provide security for the NFC card and help prevent unauthorized use, the authentication device may be configured to disable the NFC tag after a predetermined amount of time has elapsed. At block 480, the microcontroller may disable the NFC card generally using any of the methods described above; alternately, the NFC card may be disabled upon de-energizing the card. Method 450 ends after the NFC card is disabled.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., commercial transactions, security, inventory, etc.) or related data available in the cloud. For example, a commercial transaction application could execute on a computing system in the cloud, receiving data from and providing data to a NFC device (such as NFC reader 150) in order to complete a transaction. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
in response to receiving, at an authentication device of a first near field communication (NFC) device, a pressure pattern corresponding to an authentication signal that matches a stored authentication signal, enabling a NFC tag of the first NFC device to enable communication with a second NFC device.

2. The method of claim 1, wherein the authentication device comprises a piezoelectric element.

3. The method of claim 1, further comprising using the received authentication signal to provide power to the authentication device.

4. The method of claim 3, further comprising storing at least a portion of excess power provided by the received authentication signal to an energy storage element.

5. The method of claim 1, further comprising disabling the NFC tag after a predetermined amount of time.

6. The method of claim 1, wherein the stored authentication signal is one of a plurality of stored authentication signals that each correspond to a respective user profile, and further comprising altering the output provided by the NFC tag based on a user profile corresponding to the stored authentication signal.

7. The method of claim 6, wherein the output provided by the NFC tag includes account information for a user associated with the user profile.

8. A near field communication (NFC) device, comprising:
an NFC tag; and
an authentication device configured to, based on a received pressure pattern, selectively enable the NFC tag and thereby selectively enable communication between the NFC device and a second NFC device.

9. The NFC device of claim 8, wherein the authentication device comprises a piezoelectric element, and wherein the authentication device is configured to selectively enable the NFC tag based on an authentication signal corresponding to the pressure pattern received at the authentication device.

10. The NFC device of claim 9, wherein the authentication signal is configured to provide power to the authentication device.

11. The NFC device of claim 10, further comprising an energy storage element configured to store at least a portion of excess power provided by the authentication signal.

12. The NFC device of claim 9, wherein the piezoelectric element comprises a film having a plurality of sensing points, and the authentication signal is based on electric charge sensed at one or more of the sensing points.

13. The NFC device of claim 8, wherein the authentication device is further configured to disable the NFC tag after a predetermined amount of time.

14. The NFC device of claim 8, wherein the authentication device is configured to selectively enable the NFC tag when the authentication signal matches a stored authentication signal.

15. The NFC device of claim 14, wherein the stored authentication signal is one of a plurality of stored authentication signals that each correspond to a respective user profile, and further comprising altering the output provided by the NFC tag based on a user profile corresponding to the stored authentication signal.

16. The NFC device of claim 15, wherein the output provided by the NFC tag includes account information for a user associated with the user profile.

17. A self-powered input device, comprising:
a piezoelectric element; and
a processor configured to receive power and data from the piezoelectric element.

18. The self-powered input device of claim 17, further comprising an energy storage element configured to store at least a portion of the power received from the piezoelectric element.

19. The self-powered input device of claim 18, wherein the processor is further configured to receive stored power from the energy storage element.

20. The self-powered input device of claim 17, wherein the piezoelectric element comprises a film having a plurality of sensing points, and the received data is based on electric charge sensed at one or more of the sensing points.
